(19) United States
(12) Patent Application Publication
(10) Pub. No.: US 2011/0196702 A1
(43) Pub. Date: Aug. 11, 2011

(54) INTEGRATED SYSTEM AND METHOD OF PROVIDING SERVICES

(76) Inventors: Marcus Hani Salouk, Queensland (AU); Per Matthew Firor, Queensland (AU); William Norton Higbie, Victoria (AU); Gregory Norman Wells, New South Wales (AU)

(21) Appl. No.: 12/160,711

(22) PCT Filed: Jan. 11, 2007
(86) PCT No.: PCT/AU07/00020

§ 371 Date: Mar. 7, 2011

(30) Foreign Application Priority Data
Jan. 11, 2006 (AU) 2006900130

(51) Int. Cl. G06Q 50/00; G06Q 10/00

(52) U.S. Cl. 705/3; 705/2

(57) ABSTRACT

The present invention provides a method of improving the delivery of services of a health care system by the application of a business change process to an existing health care system including the steps of: identifying components of patient experience as a patient is processed through the health care system; extracting existing data included in one or more data bases, pertaining to the health care system, identifying existing data that correlates with components of the patient experience and extracting that data and associating it with the relevant component, or interfaces therebetween, for subsequent analysis; obtaining a measure of the performance of the patient experience components by applying pre-defined checklists of queries to each identified component, and interfaces therebetween, and obtaining and rating responses to the queries, said patient responses collected from devices in electronic communication with a data gathering and recordal system and combining with any relevant existing data as it pertains to corresponding components; identifying services in the patient experience components, and the interfaces therebetween, that require improvement by comparing the electronically stored data pertaining to rated responses and any available correlating data obtained from the health care system with predefined indicators in relation to the provision of health care services; and generating an electronic report that identifies the patient experience components and interfaces therebetween and includes an indication of those components and/or interfaces requiring improvement.

### FIELD OF THE INVENTION

This invention relates to the delivery of services in a health care system. It relates particularly, but not exclusively, to a method of improving the delivery of services of a health care system by the application of a business change process to an existing health care system.

### BACKGROUND TO THE INVENTION

The problems associated with efficient running of a health care system are often substantial. An efficient health care system requires a sufficient number of trained health care service providers and sufficient medical facilities to meet each type of health care need, as well as sufficient funds to pay for the medical facilities and health care providers. However, the cost of medical facilities and health care services is almost always too great to allow for a pure user-pays system, and funding solely provided by governments, charities, and insurance companies is often insufficient to enable the health care system to operate efficiently.

Inefficient business processes can reduce the time that health care workers have available for the delivery of front-line patient care. For example, if health care workers are required to perform excessive administrative duties then they have less time to focus upon providing health care. Reduction in the amount of available front-line patient care and a lack of adequately equipped medical facilities can result in substantial delays in the provision of health care services to those in need. Additionally, inadequate communication between different health care providers can also result in sub-optimal provision of health care services to patients and non-availability of relevant medical records can often result in inappropriate health care treatment of patients.

An efficient health care system requires a vast range of issues to be managed, including: appropriate strategies to cater for projected health care demands, adequate monitoring of the quality of health care services provided, risk and performance management, co-operation between different health care providers, adequate capital investment in medical facilities, appropriate management of patient records, efficient information management to support service delivery, and continuing education for health care providers.

Previous efforts to improve health care systems have typically been directed towards one aspect or a limited range of aspects of health care systems. For example, typical health care reform and re-engineering projects have previously focused on specific areas within hospital environments in an attempt to improve, or at least ameliorate, the inefficient provision of health care services to patients. In one known example, the radiology department of a hospital conducted an operational review of the provision of its services to patients where the review was conducted in isolation of the rest of the hospital or the overall health care system. As a result, this particular review devised a solution including restructuring of appointment times to better utilize available equipment within the radiology department but did not take into consideration future patient demand in view of patients awaiting referral to the radiology department from the emergency department.

Unfortunately, attempts to reform and re-engineer health care systems to ameliorate their present deficiencies is not significantly assisted by focusing upon individual departments within a hospital or health care system as each hospital department or entity within a health care system is not an isolated entity and their performance and actions impact upon the efficiency of the provision of health care services during the provision of additional services in subsequent stages of the health care system.

Despite past attempts to address inefficiencies and provision of health care services by the development of patient care data systems, implementing improved health care worker training programs and improved risk management systems, health care systems throughout the world continue to suffer from significantly sub-optimal performance with respect to the delivery of health care services to patients.

The reference to any prior art in this specification is not, and should not be taken as, an acknowledgement or any form or suggestion that the prior art forms part of the common general knowledge in Australia.

### SUMMARY OF THE INVENTION

In one aspect, the present invention provides a method of improving the delivery of services of a health care system by the application of a business change process to an existing health care system including the steps of:

identifying components of patient experience as a patient is processed through the health care system;

extracting existing data included in one or more data bases, pertaining to the health care system,

identifying existing data that correlates with components of the patient experience and extracting that data and associating it with the relevant component, or interfaces therebetween, for subsequent analysis;

obtaining a measure of the performance of the patient experience components by applying pre-defined checklists of queries to each identified component, and interfaces therebetween, and obtaining and rating responses to the queries, said patient responses collected from devices in electronic communication with a data gathering and recordal system and combining with any relevant existing data as it pertains to corresponding components;

identifying services in the patient experience components, and the interfaces therebetween, that require improvement by comparing the electronically stored data pertaining to rated responses and any available correlating data obtained from the health care system with predefined indicators in relation to the provision of health care services; and

generating an electronic report that identifies the patient experience components and interfaces therebetween and includes an indication of those components and/or interfaces requiring improvement.

Identifying components of patient experience as a patient is processed through a health care system, sometimes referred to as the “patient journey”, provides a focus and methodology for the measurement of the performance of a health care system and the application of a change management process to improve and monitor the performance of that system. For example, by measuring the experience of each patient as they progress through a health care system it is possible to identify and measure important characteristics of the patient experience such as delays associated with movements through the health care system and errors with respect to medication or implementation of clinician treatment that ultimately impact upon the efficiency of the overall health care system. Errors or inappropriate scheduling of resources can have a significant impact upon the efficient delivery of health services and identifying components of the patient experience that relate to these issues provides a mechanism by which any such errors and/or resource scheduling problems can be identified and quantified.

Collectively, when data is gathered from all patients, it becomes possible to identify those components of the patient experience that are in greatest need of attention and will bring about the most immediate result when applying a change management process to improve the efficiency of that component, and hence the overall health care system.

Further, errors and/or inappropriate scheduling of resources at an early stage in the patient experience as they progress through the health care system can have a compounding negative impact upon the efficiency of health service delivery in subsequent stages. Accordingly, the application of change management processes to address inefficiencies at early stages of the patient journey may simultaneously improve the efficiency of downstream services.

As compared with previous attempts to improve the efficiency of health care systems, the patient journey focus takes into account the fact that each entity within the health care system is inter-connected with other entities and the efficiency of each entity is affected by any inefficient practices occurring within any other inter-connected entity. Furthermore, focusing on the patient journey allows for greater teamwork from hospital staff and contributes to an environment with more respect and understanding of each department's role, and the impact of that department's role upon other entities within the health care system, which in turn leads to better overall patient care and efficient operation of the health care system.

An important aspect of the method of improving the delivery of services of a health care system is the extraction of existing data from a health care system pertaining to the processing of patients, and correlating the existing data with the components of patient experience and/or interfaces therebetween. Usually, in hospital environments, overwhelming quantities of data are available although the data is not generally readily accessible in a useful or readily usable form to quickly determine the efficiency of operation of the health care system. However, extracting relevant portions of existing data that correlates closely with components of the patient experience, or components therebetween, provides crucial support for determining those aspects of the health care system that require improvement. Of course, the extent to which there is available existing data in the health care system that correlates with components of a patient experience will vary according to the individual health care system. However, it is expected that there will be at least some useful data stored in existing health care systems that will correlate to some extent with one or more components of a patient experience, or interfaces therebetween.

In one embodiment of the invention, the availability of existing data that correlates with components of a patient journey is tracked in order to identify those components of the patient journey, and/or interfaces therebetween, for which there is no existing available data thus identifying aspects of the patient journey for which data should be collected in future.

Of course, errors and/or inappropriate resource scheduling only represent some of the potential problems that can have a negative impact upon the efficiency of health service delivery and in embodiments of the invention the pre-defined checklist of queries relating to each identified component, and interfaces therebetween, is arranged to identify as many sources of inefficiency as possible.

In addition to taking into account the components of the patient journey, in an embodiment, the system takes into account any other factors relevant to the performance of the health care system, and uses those factors as inputs to the business change process. Suitable factors include desired strategic directions, anticipated future demand for services, regulatory factors, and risk factors.

In another aspect, the present invention provides a method of operating a health care system including the steps of:

collecting data from patients using devices in electronic communication with a data gathering and recordal system the data relating to relevant aspects of components of the patient experience, or interfaces therebetween, as patients are processed through the health care system;

analyzing the collected dated to obtain a measure of the performance of the components of the patient experience, and/or interfaces therebetween;

rating the collected responses from the patients and comparing same with pre-defined indicators relating to the efficient provision of health care services; and

reporting the results of the rated responses and comparison with pre-defined indicators on a visual display unit wherein the displayed data is arranged in a form that readily identifies each patient experience component, and/or interface therebetween, in substantially the same order in which a patient experiences those components as they progress through the health care system.

In an embodiment, the method described above is implemented in the context of an integrated data system applied to an entire health care system, with an integrated patient record covering at least each component of the patient experience. The integrated data system may include an electronic bedboard located in the proximity of a patient's bed, which allows for data entry concerning a patient's monitored condition and medication and data reporting to provide an overview of the patient's progress through the health care system.

The bedboard may provide a range of functionality including the ability to function as a data input device for receiving patient entered data pertaining to the components of the patient journey and/or the level of patient satisfaction with the delivery of health care services. Further, by receiving clinician entered data, the bedboard may act as a data entry point that assists the maintenance of an integrated Electronic Health Record (EHR) with up to date data reflecting the patient's current status. In an embodiment, the current status of a patient is used to predict the requirement for future service delivery and this information is passed to the affected health care departments to enable them to schedule the necessary resources in anticipation of forthcoming requirements.

In an embodiment of the invention, the method includes the step of applying change processes that result in a reduction in cost of running the health care system, and a proportion of the cost reduction is used to fund the application of the business change process.

In an embodiment of the invention the report appearing on a visual display unit, sometimes referred to a “dashboard”, provides the report on a single screen resulting in the provision of a summary of the key performance indicators for each component of the patient experience in a single view. In further embodiments, the report is regularly updated with data as it is collected thus enabling users to view the performance of the components of the patient experience with up to date information.

In some instances, users may only need to obtain a report on a weekly basis in order to ensure that components of the health care system remain operating at an efficiency greater than the pre-defined indicators. However, in other instances, users may need to obtain reports on a more regular basis to ensure that other components of the health care system remain operational at an efficiency level that is considered acceptable. Despite the regularity of reports required by individual administrators of the health care system, the presentation of information arranged in a manner that substantially aligns with the patient journey through the health care system results in improved understanding of the state of the operational efficiency of a health care system and, at any particular point in time, those components of the health care system that require attention as a result of operation at a level of efficiency less than the components pre-defined indicator.

The presentation of operational efficiency information arranged substantially in accordance with the steps of a patient journey may also provide an improved understanding of the reasons why any one or more components of the patient experience are operating at a sub-standard efficiency level.

In another aspect, the present invention provides an integrated data system for the delivery of health care services in a health care system including:

a data gathering part which gathers and records data collected by devices in communication with a data recordal system;

a measuring part which measures the performance of patient experience components by extracting recorded data pertaining to each component and by providing patients with pre-defined checklists of queries relevant to each component, and/or the interfaces therebetween, each patient providing responses by operation of a device and recording and rating the extracted data and the responses to the queries; and

a discrepancy identification part which identifies services in the patient experience components, and/or the interfaces therebetween, that require improvement by comparing the recorded and rated data and responses with predefined indicators.

In an embodiment of the invention, one or more of the following parts or steps are included:

1. An articulated vision of reform for a Health Department.
2. A solution map that outlines the targeted scope of improvement and how technology will be used to deliver sustained improvement to the delivery of health services.
3. Checklists that identify the target areas of improvement (i.e. the key questions to ask), and typical measures of a Health Department's performance thus enabling benchmarking of the Health Department services and identification of the scope of improvement required that can be used as a quantifiable input to a business case for implementing a change process.
4. Methodology for undertaking integrated and holistic health system reform integrating strategy, business process re-engineering, change management and the implementation of technology and operations.
5. Workplan for undertaking the transformation in an integrated manner that delivers sustainable change over time identifying key milestones at short and long term intervals.
6. Business case template that enables program costs and targeted benefits to be captured and an overall economic position to be outlined.
7. Business model that outlines how the implementation cost can be subsidized which may be supported by spreadsheets that model benefits (cashable, non cashable and non-dollar), costs the and overall business case position. The model may cater for a private financing option (e.g. via a third party investment arrangement).
8. A commercial procurement model that outlines how incentives can be aligned by linking a component of profit to outcomes.

### BRIEF DESCRIPTION OF THE DRAWINGS

One or more embodiments of the invention will now be described in greater detail by reference to the attached drawings in which:

FIG. 1 is a flow diagram showing an embodiment of the method of the invention;

FIG. 2 is a diagram of the patient experience according to an embodiment of the invention;

FIG. 3 is a roadmap detailing the implementation steps of an embodiment of the invention;

FIG. 4 is an illustration of a workplan for implementing an embodiment of the invention;

FIG. 5 is an illustration of a patient flow management solution map for use in an embodiment of the invention;

FIG. 6 is an illustration of an example of a system architecture suitable for electronic referral and patient scheduling for use in an embodiment of the invention;

FIG. 7 is an illustration of a single health-system-wide repository suitable for use in an embodiment of the invention;

FIGS. 8a and 8b are an illustration of an example checklist for use in an embodiment of the invention; and

FIG. 9 is an illustration of an electronic dashboard for use in an embodiment of the invention.

### DETAILED DESCRIPTION OF EMBODIMENTS

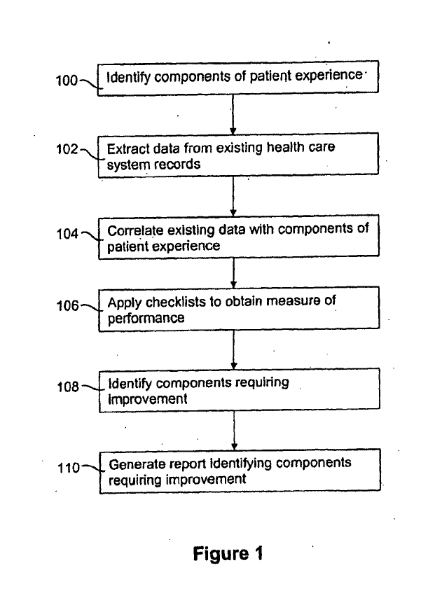

Referring firstly to FIG. 1, there is shown a method of improving the delivery of services of a health care system by the application of a business change process to an existing health care system. The first step (100) involves identifying components of a patients experience as the patient is processed through the health care system. The second step (102) involves extracting data from existing health care system records and step 104 correlates any existing data with components of the patient experience. Step 106 involves obtaining a measure of the performance of the components of the patient experience and the interfaces therebetween, by applying extracted and correlated data and feedback from pre-defined checklists of queries to each identified component, and interface, and rating responses to the queries.

Step 108 involves identifying services in the patient experience components, and/or the interfaces therebetween, that require improvement by comparing the rated responses with predefined indicators. Step (110) involves the generation of a report identifying those components requiring improvement.

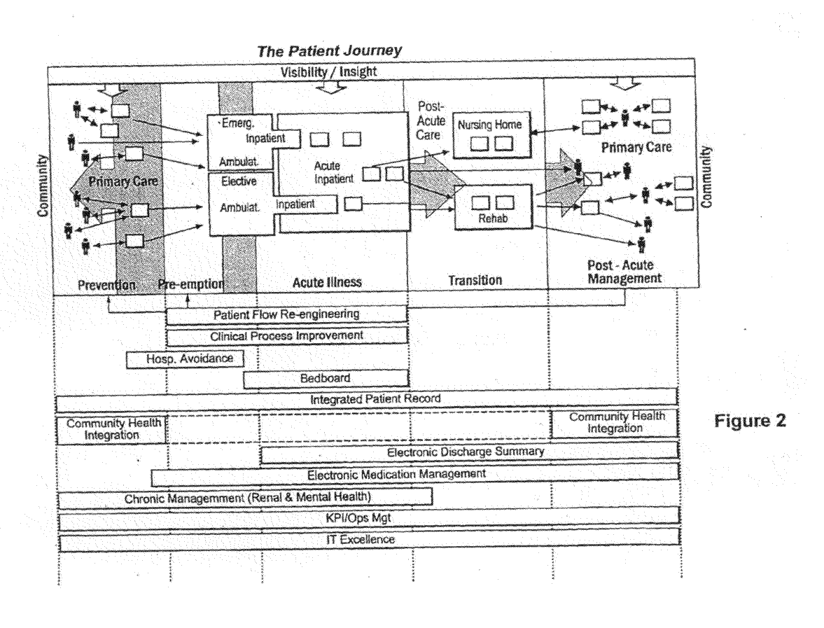

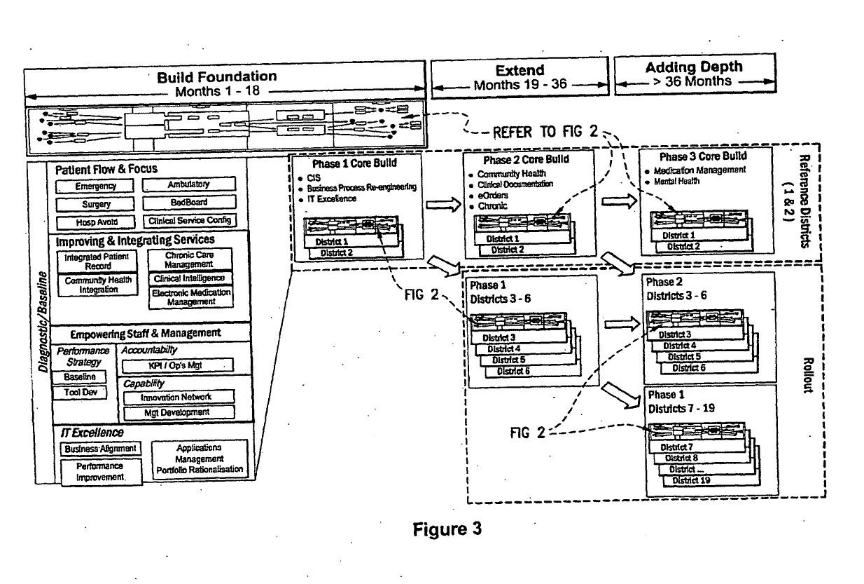

Referring to FIG. 2, the “patient journey” according to an embodiment of the present invention places the patient at the centre of the reform program and equips the patient and all treating clinicians with the most relevant information at the point of care. Clinical systems implementations are generally more successful when business process reform is used on the primary systems requirement input to the implementation of the health care system.

The “patient journey” is defined by each interaction the patient has with the health system throughout their entire experience of the health care system including primary care, community care and acute/secondary care. While each individual patient journey is different, patients typically move from primary/community care, through acute/secondary care and then back into primary/community care (except in the case of accidents and emergencies). Integration of processes and information whilst a patient progresses through the health care system significantly enhances the achievement of improvements in the quality of care experience and health outcomes.

To achieve an improved patient journey, information systems should be deployed across the various health care stages in conjunction with a re-examination of the clinical processes and patient management practices. In an embodiment, central elements of the information systems include:
An integrated Electronic Health Record (EHR)—a single, shared, electronic record of all relevant details associated with an individual's current health status including, current and past diagnoses and treatment, medication records and other relevant health information
Electronic Discharge Summaries providing timely communication of key information from critical care to primary/community care to ensure safe and effective transition;
Electronic Medication Management providing automated support for prescription, supply, administration of medication and the creation of a reliable, complete medication record reducing dangerous and costly drug/drug, drug/treatment, drug/food (etc) interactions; and
Key Performance Indicators (KPIs)/Operations Management systems and processes that support operational systems and create valuable business intelligence, without significantly increasing data collection effort.

Referring to FIG. 3, an implementation of the method is illustrated. This particular implementation focuses on four main areas:
1. Patient Focus and Flow—working with clinicians and administrators to ensure that all processes are arranged with the patient and the flow of the patient through the health care system as the focus, and improving these processes to make them more efficient and have a more positive impact on health outcomes.
2. Improving and Integrating Services—deploying systems that support patient focussed processes and enabling the sharing of critical health information across health care stages and at relevant times and locations throughout the health care system when such information is required.
3. Empowering Staff and Management—new processes will generally not be effectively adopted without motivated and engaged staff so it is desirable to create a learning environment and provide tools (eg patient flow dashboards, electronic bedboards etc) that help front line staff and management to better perform their tasks, better use critical resources, and ultimately create a high performance culture.
4. IT System and Application Management delivery of IT services and systems to support new and improved clinical processes are required to ensure the success of any implementation of a business change process.

Any integrated reform process requires careful planning. Implementation speed, risk management and value creation are balanced in this example implementation by gradual implementation of new systems and processes initially across 2 districts and delayed implementation across remaining districts as they become ready.

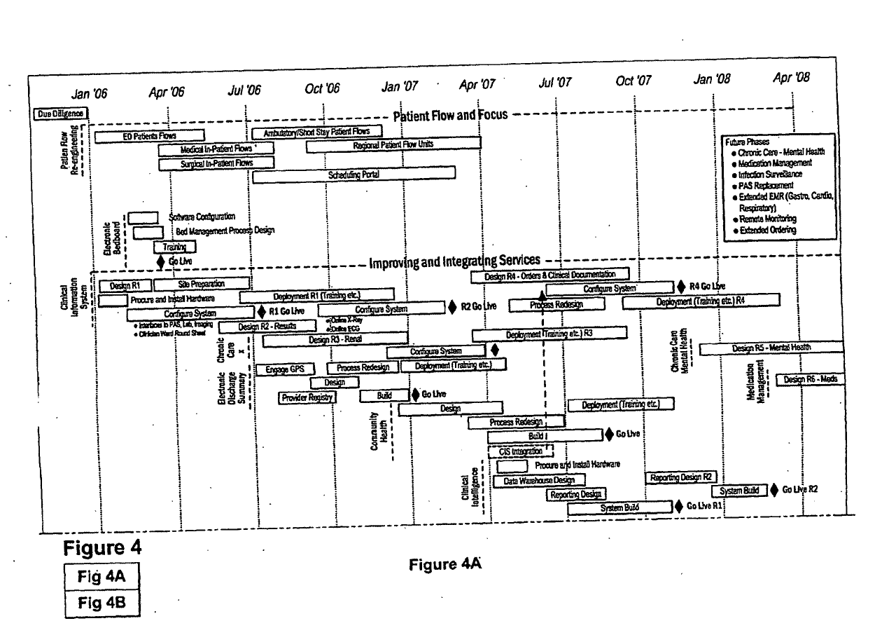

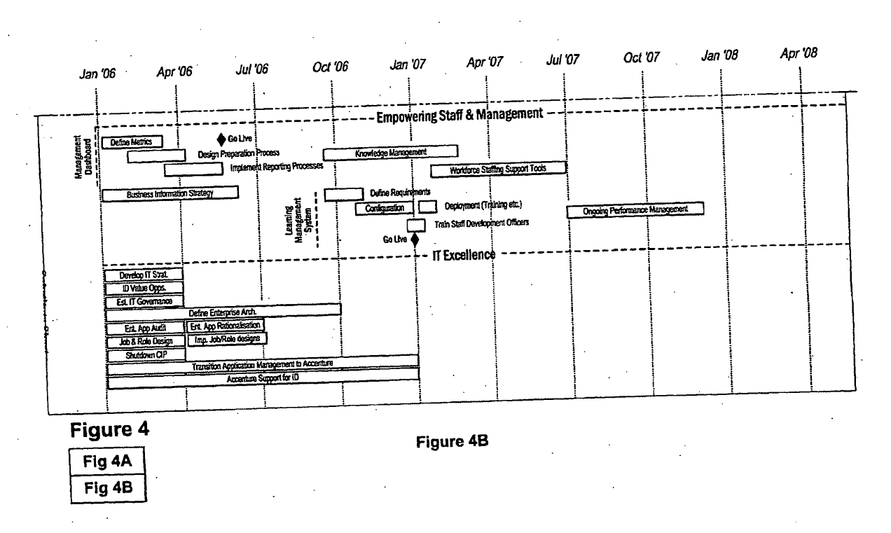

Referring to FIG. 4, the draft program plan of the implementation of an embodiment integrates the activities required to implement the first few phases of the method. Process re-engineering, training, information technology, implementation and management activities are integrated to deliver phases of new, improved business capabilities.

The “Patient Flow and Focus” component in the illustrated example includes patient flow re-engineering and the “electronic bedboard” system. An electronic bedboard is generally an electronic version of a manual bedboard, on which health care personnel enter data relevant to the patient's condition and medication. The direct entry of this information into an electronic data system enables faster and more efficient communication and retrieval of patient data. In an embodiment, the electronic bedboard may also be used to collect responses from patients with respect to the checklist of queries pertaining to the component of the patient journey relevant to the patient's location.

Patient flow re-engineering in the illustrated example includes Emergency Department patient flows, medical in-patient flows, surgical in-patient flows, ambulatory/short stay patient flows, regional patient flow units and a scheduling portal. It will be appreciated that these items are illustrative rather than prescriptive.

The “Improving and integrating services” component in the illustrated example includes a clinical information system, a chronic care system, an electronic discharge system, a community health system, a clinical intelligence system, a chronic care mental health system, and a medication management system. Example timelines are illustrated in FIG. 4 for design, configuration and deployment of these systems.

The “empowering staff and management” component in the illustrated example includes a “management dashboard” and a learning management system. The management dashboard provides reporting to management on key metrics, which can be defined for any particular application.

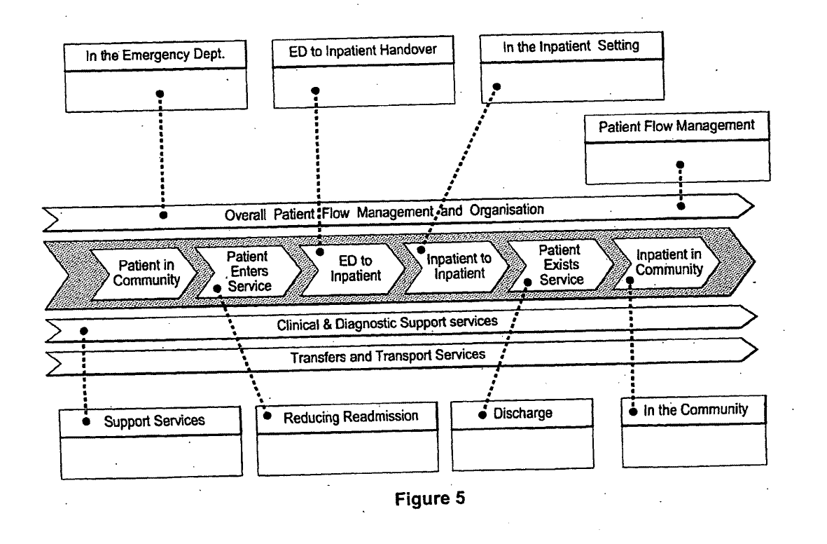

FIG. 5 shows a patient flow solution map according to an embodiment of the invention. The purpose of a solution map is to outline the targeted scope of improvement and how technology will be used to deliver sustained improvement. The notional flow illustrated in the centre of FIG. 5 shows the following steps:

1. Patient in community.
2. Patient enters service.
3. Emergency department to inpatient.
4. Inpatient to inpatient.
5. Patient exits service.
6. Patient in community.

The boxes surrounding the central flow illustration in FIG. 5 describe possible aspects of the patient flow solution, namely:

In the Emergency Department (ED)
Streamline the clerical admission process
Align team hours & skill mix to the patient demand
Monitor patient flow to agreed benchmarks
Rationalise test ordering
Streamline Emergency Department to inpatient handover
Use risk screens

Emergency Department to Inpatient Handover
Streamline the inpatient to Emergency Department handover—use Nurse escorts only when required
Dedicated Transport Team
Reengineer the Flow of Patient Information

In the Inpatient Setting
Daily Care Coordination Meetings & Estimated Discharge Date (EDD)
Standardised Allied Health Referral Process
Coordinated Care Plans
Improvements to visibility/timing of ward rounds
Event Driven Discharge Protocols
Long Length of Stay Meetings

Patient Flow Management
Bed/Service reconfiguration
Patient flow protocols
KPI Dashboard
Governance & accountability frameworks
Patient flow units

Discharge
Discharge scripts & discharge summaries the day before discharge
Discharge checklists
Patient Discharge Lounges

Reducing Readmission
Aged care Services Emergency Team (ASET)
Allied Health
Community Nursing
Clinical Support Nurse/Clinical Nurse Consultant (CNC)

In the Community
Service directory
Central intake
Transitional care
Residential Placement Service
Coordinated Care Models including Rapid Responses Acute
Community Care (RRACC) and Hospital in the Home (HITH)

Support Services
Extended hours of support
Test prioritisation to include operational urgency
Streamlined test ordering & results reporting
Time of Discharge Scripts

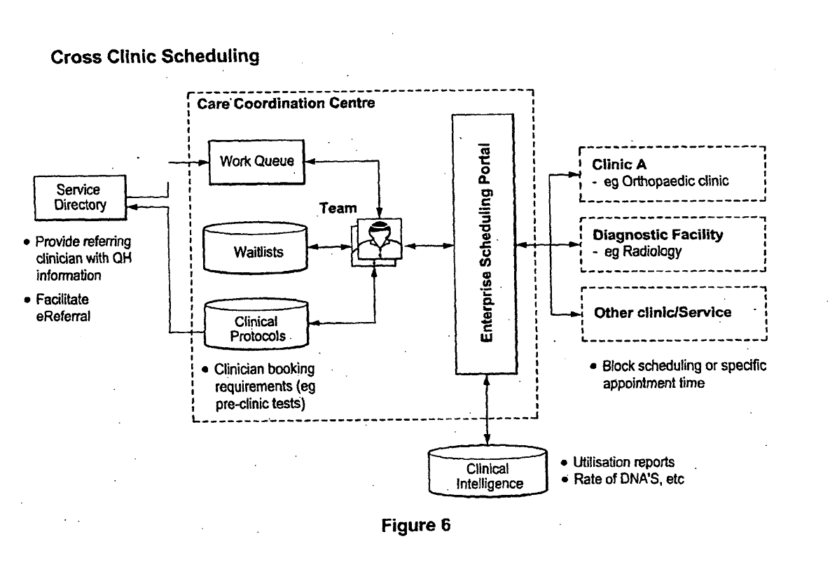

FIG. 6 is an illustration of an example of architecture suitable for electronic referral and patient scheduling for use in an embodiment of the invention. A care coordination centre includes a work queue, waitlists, clinical protocols and an enterprise scheduling portal. Key architecture characteristics include:
Central coordination of appointments
Enterprise scheduling—visibility of all necessary schedules.
Clinical Protocols informs referral and scheduling requirements.
Coordinated scheduling and use of clinical protocols leading to reduction in the length/complexity of the patient journey—also resulting in the correct patient being delivered at the correct time to the treating clinician.
Central coordination monitoring District/hospital record of patient demand and supply/waitlist management

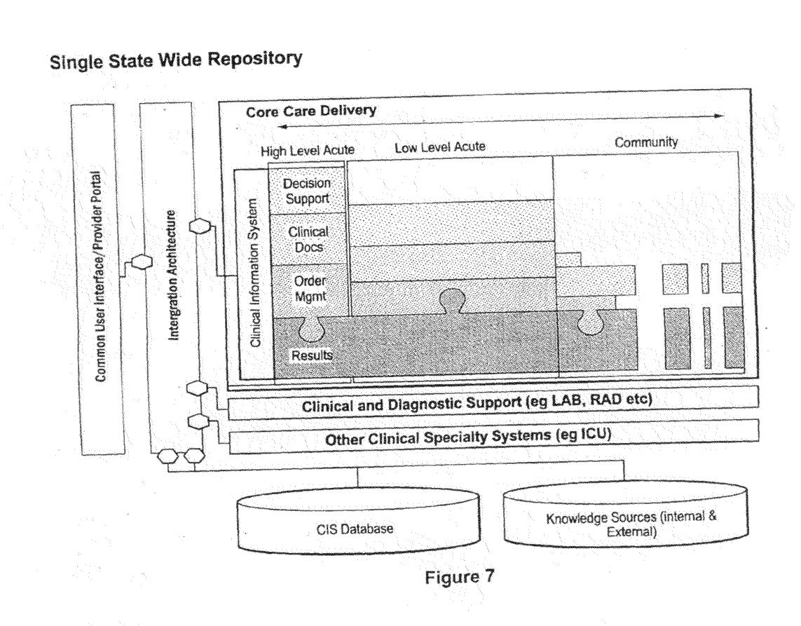

FIG. 7 is a diagrammatic illustration of a single health-system-wide repository suitable for use in an embodiment of the invention. A common user interface communicates with integration architecture which in turn communicates with clinical information systems such as decision support systems, clinical document systems, order management systems and results systems, as well as with clinical and diagnostic support systems and other clinical specialty systems. Preferred architectural characteristics of a single health-system-wide repository include:
Enabling a single view of all patient interactions with the relevant health care system;
Facilitating the sharing of information within high level acute (eg Tertiary hospital), low level acute (eg smaller acute facility), and community healthcare settings;
Reduction in information duplication;
Greater efficiencies through single point integration with EHR and specialty systems.
   In an embodiment of the invention, once the process re-engineering stage has been completed, and the necessary changes have been implemented resulting in a system operating at efficiency levels that are considered acceptable, it is then necessary to monitor the system to ensure the continued efficient performance of the health care system. In one particular embodiment where a comprehensive IT system records relevant data relating to components of the patient journey, and/or interfaces therebetween, the data is analyzed to determine trends over periods of time further enabling health care system administrators to proactively manage resources.

Integrated IT systems assist with the empowerment of staff and management personnel in the health care system.

In one embodiment, components of the IT system include:

Electronic bedboards;

Nursing Unit Manager (NUM) support tools; and

Patient flow dashboards.

Further aspects that assist the implementation of any change management include:

Direct participation and leadership of the change program by staff; and

Knowledge sharing and learning management.

The results of empowering staff and management include:

Creating a performance culture;

Sustained improvements in patient flow;

Better matching of staff to patient demand;

Improved bed utilisation/turnover; and

Improved theatre utilization.

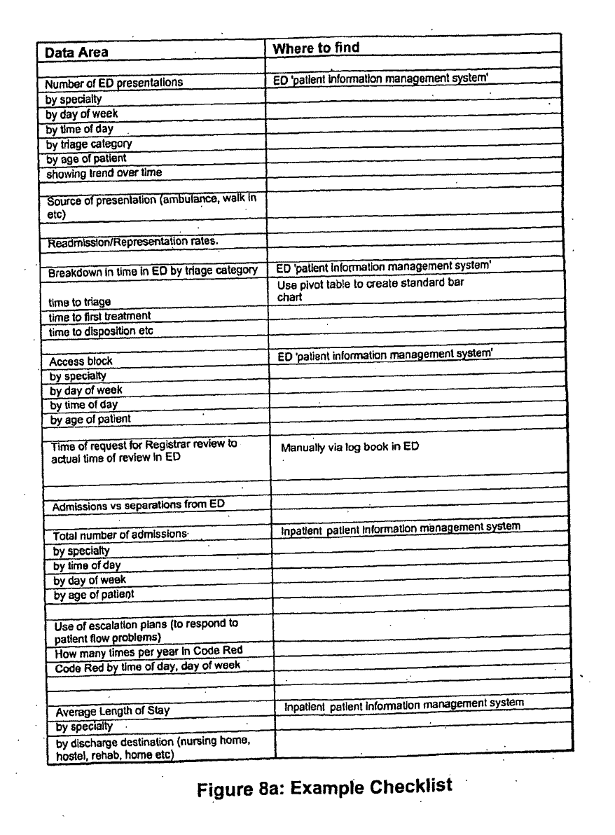

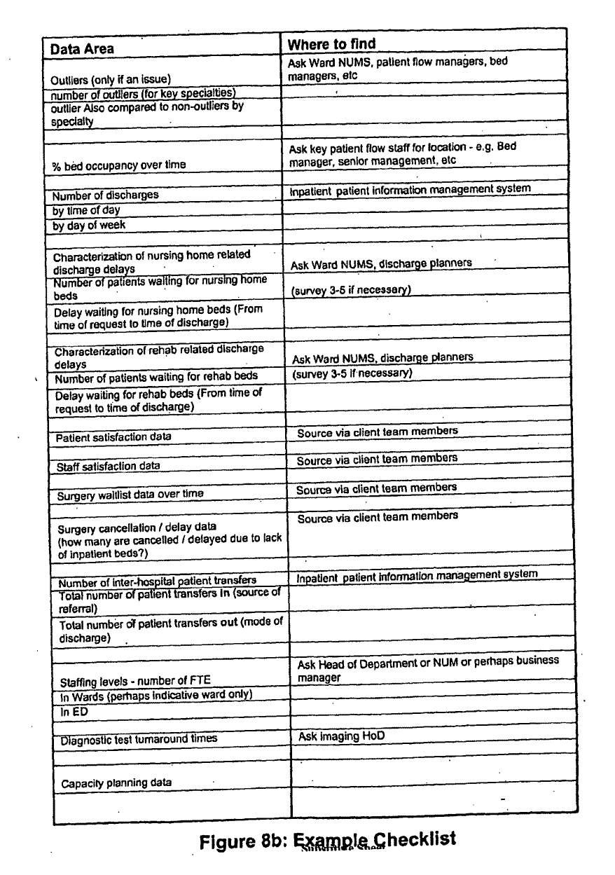

FIGS. 8a and 8b provide an example checklist of an embodiment of the invention. The purpose of the checklist is to identify typical measures of a health system's performance, and to identify these areas that can be improved or require improvement to meet an established standard. The use of checklists enables faster completion of business process re-engineering and design, and standardises the process to ensure that it is repeatable. Further, such checklists may also be used subsequent to the implementation of a re-engineering of the health care processes to provide ongoing monitoring post implementation.

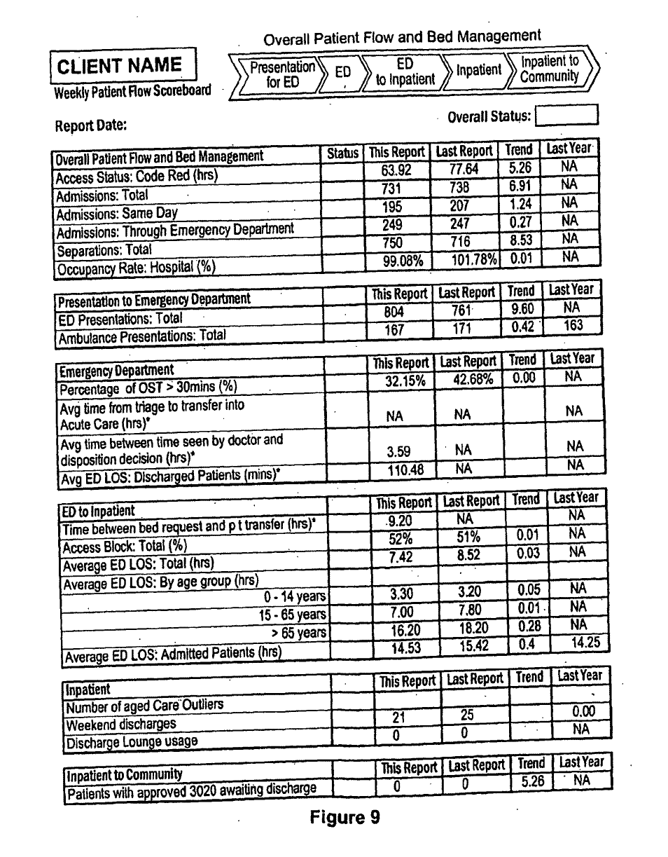

FIG. 9 is a diagrammatic illustration of an example electronic dashboard for use in an embodiment of the invention. In this case, the electronic dashboard is a weekly patient flow scorecard, providing information concerning overall patient flow and bed management, presentations to the emergency department, emergency department statistics, emergency department to inpatient statistics, inpatient statistics, and inpatient to community statistics. The purpose of the electronic dashboard is to provide an administrator critical information concerning patient traffic flow and blockages to throughput in the health care system.

It is to be understood that various alterations, modifications and/or additions may be made to the parts and/or steps previously described without departing from the ambit and spirit of the invention.

1-16. (canceled)

17. A method of improving the delivery of services of a health care system by the application of a business change process to an existing health care system including the steps of:
identifying components of patient experience as a patient is processed through the health care system;
extracting existing data included in one or more data bases, pertaining to the health care system,
identifying existing data that correlates with components of the patient experience and extracting that data and associating it with the relevant component, or interfaces therebetween, for subsequent analysis;
obtaining a measure of the performance of the patient experience components by applying pre-defined checklists of queries to each identified component, and interfaces therebetween, and obtaining and rating responses to the queries, said patient responses collected from devices in electronic communication with a data gathering and recordal system and combining with any relevant existing data as it pertains to corresponding components;
identifying services in the patient experience components and the interfaces therebetween that require improvement by comparing the electronically stored data pertaining to rated responses and any available correlating data obtained from the health care system with predefined indicators in relation to the provision of health care services; and
generating an electronic report that identifies the patient experience components and interfaces therebetween and includes an indication of those health care services and/or interfaces therebetween requiring improvement

18. A method of improving the delivery of services of a health care system according to claim 17 further including the steps of:
identifying one or more of the following additional inputs to the business change process:
(a) desired strategic directions;
(b) anticipated future demand for services;
(c) regulatory factors; and
(d) risk factors; and
taking account of the one or more additional inputs in the step of applying change processes.

19. A method of improving the delivery of services of a health care system according to claim 17 wherein the step of applying change processes results in a reduction in cost of running the health care system, and the cost reduction is used to fund the application of the business change process.

20. A method of operating a health care system including the steps of:
collecting data from patients using devices in electronic communication with a data gathering and recordal system,
the data relating to relevant aspects of components of the patient experience, or interfaces therebetween, as patients are processed through the health care system;
analyzing the collected dated to obtain a measure of the performance of the components of the patient experience, and/or interfaces therebetween;
rating the collected responses from the patients and comparing same with pre-defined indicators relating to the efficient provision of health care services; and
reporting the results of the rated responses and comparison with pre-defined indicators on a visual display unit wherein the displayed data is arranged in a form that readily identifies each patient experience component, and/or interface therebetween, in substantially the same order in which a patient experiences those components as they progress through the health care system.

21. A method of operating a health care system according to claim 20 further including the step of using an integrated data system applicable to the entire health care system, with an integrated electronic health record covering each component of the patient experience.

22. A method of operating a health care system according to claim 21 wherein the integrated data system includes electronic referral of patients and electronic scheduling of health care services.

23. A method of operating a health care system according to claim 21 wherein the integrated data system includes an electronic bedboard which allows for data entry concerning a patient's monitored condition and medication.

24. A method of operating a health care system according to claim 23 wherein the integrated data system includes electronic referral of patients and electronic scheduling of health care services.

25. A method of operating a health care system according to claim 21 wherein the bedboard accepts data entry from patients in relation to components of the patient experience.

26. A method of operating a health care system according to claim 25 wherein the integrated data system includes electronic referral of patients and electronic scheduling of health care services.

27. An integrated data system for the delivery of health care services in a health care system including:
a data gathering part which gathers and records data collected by devices in communication with a data recordal system;
a measuring part which measures the performance of the patient experience components by extracting recorded data pertaining to each component and by providing patients with pre-defined checklists of queries relevant to each component, and/or the interfaces therebetween, each patient providing responses by operation or a device and recording and rating responses to the queries; and
a discrepancy identification part which identifies services in the patient experience components and the interfaces therebetween that require improvement by comparing the recorded and rated data and responses with predefined indicators.

28. An integrated data system for the delivery of health care services in a health care system according to claim 27 further including:
an additional input processing part which identifies one or more of the following additional inputs to the business change process and takes account of the one or more additional inputs in applying change processes:
(a) desired strategic directions;
(b) anticipated future demand for services;
(c) regulatory factors; and
(d) risk factors.

29. An integrated data system for the delivery of health care services in a health care system according to claim 27 further including an electronic health record for each patient including data recordal fields for at least each component of the patient experience.

30. An integrated data system for the delivery of health care services in a health care system according to claim 29 further including an electronic bedboard which allows for data entry concerning a patient's monitored condition and medication.

31. an integrated data system for the delivery of health care services in a health care system according to claim 29 wherein the electronic bedboard accepts data entry from patients in relation to components of the patient experience.

32. An integrated data system according to claim 27 wherein the discrepancy identification part generates an electronic report that includes the patient experience components and the interface therebetween identifying those components and interfaces requiring improvement.

33. An integrated data system according to claim 32 wherein the report is arranged in a form that readily identifies each patient experience component and the interfaces therebetween in substantially the same order in which a patient experiences those components as they progress through the health care system.

34. An integrated data system for the delivery of health care services in a health care system according to claim 27 further including electronic referral of patients and electronic scheduling of health care services.
